(19) United States
(12) Patent Application Publication
(10) Pub. No.: US 2014/0340282 A1
(43) Pub. Date: Nov. 20, 2014

(54) SOC FOR SUPPORTING MULTIPLE DISPLAY SCREENS AND CONFIGURATION METHOD THEREOF

(71) Applicant: SAMSUNG ELECTRONICS CO., LTD., Suwon-si (KR)

(72) Inventors: Jun CHEN, Hangzhou (CN); Jincheng WANG, Hangzhou (CN)

(21) Appl. No.: 13/894,619

(22) Filed: May 15, 2013

(51) Int. Cl. G09G 3/36

(52) U.S. Cl. CPC G09G 3/36
USPC 345/1.3

(57) ABSTRACT

A system on a chip (SOC) for supporting multiple display screens includes a microprocessor controller module and an e-book display screen controller module, wherein, the e-book display screen controller module includes at least two e-book display screen controllers for controlling an e-book display screen (EPD) panels in different modes.

### BACKGROUND

Exemplary embodiments of inventive concept relate to a SOC (system on a Chip), and more particularly, to a SOC for supporting multiple display screens and configuration method thereof.

The mainly used display screen of the current e-book (also referred to as “electronic paper book”) is an E-Ink screen. The E-Ink is generally referred to as “electronic ink technology” (electrophoretic e-paper), and the electronic paper of the E-Ink is consisted of electronic ink and two substrates. The substrate is coated with the electronic ink which is consisted of numerous small transparent particles, and the diameter of the particles is only one half of the diameter of the human hair. As long as adjusting the color of the micro-particles and the dye in the particles, the electronic ink will be able to show color and pattern. When such an electronic ink is applied to paper, cloth or other plane objects, as long as the electronic ink is electric shocked properly, it will be enabled hundreds of millions of particles to change color, thereby the pattern and characters will be changed constantly according to the designer/user's settings. The E-Ink screen has the characteristic of low power consumption and faster refresh.

### SUMMARY

Exemplary embodiments of the inventive concept provide a SOC for supporting multiple display screens and a configuration method thereof.

According to an exemplary embodiment of the inventive concept, a system on a chip (SOC) for supporting multiple display screens, comprises: a microprocessor controller module and an e-book display screen controller module, wherein, the e-book display screen controller module includes at least two e-book display screen controllers for controlling e-book display screen (EPD) panels in different modes.

The SOC may further comprise a system bus, a bridge module, an e-book display screen bus and a display data controller module, wherein, the microprocessor controller module is connected the system bus, the bridge module is connected between the system bus and the e-book display screen bus, the e-book display screen controller module and the display data controller module are connected the e-book display screen bus, and communicate with the microprocessor controller module through the e-book display screen bus via the bridge module and the system bus.

Said at least two e-book display screen controllers are integrated together to form the e-book display screen controller module and share one display data controller module. The display data controller module generates corresponding EPD data according to different EPD modes. The display data controller module and the e-book display screen controller module singly occupy the e-book display screen bus.

The SOC may further comprise: a LCD controller module for controlling an LCD and connected to the system bus, wherein, the LCD controller module has a first LCD channel and a second LCD channel, the first LCD channel and an EPD channel of the e-book display screen controller module are multiplexed to be connected with an EPD panel or LCD panel, and the second LCD channel and a IP module are multiplexed be to connected with the LCD panel.

The bridge module may comprise a system bus slave interface, a protocol conversion module and an e-book display controller bus master interface, wherein, the protocol conversion module is connected between the system bus slave interface and the e-book display controller bus master interface.

The microprocessor controller module may comprise a CPU, a system controller module and a memory controller module is connected with the system bus, respectively.

According to an exemplary embodiment of the inventive concept, a configuration method of a system on a chip (SOC) chip for supporting multiple display screens, the SOC comprising a microprocessor controller module and an e-book display screen controller module, wherein, the e-book display screen controller module includes at least two e-book display screen controllers for controlling the e-book display screen (EPD) panels in different modes, comprises: judging an EPD mode according to the type of the e-book display screen by the microprocessor controller module; configuring an EPD mode of the SOC according to the judged EPD mode by the microprocessor controller module; and turning on an e-book display screen controller corresponding to the configured EPD mode among said at least two e-book display screen controllers, and remaining e-book display screen controllers being in off state.

The configuration method may further comprises configuring the SOC as one of a multi-panel mode and a single-panel mode, wherein the SOC further comprises a LCD controller module, and the single-panel mode includes a single LCD mode and a single EPD mode.

The configuration method may further comprise: when configuring the SOC as the multi-panel mode, LCD controller mode being turned on, the e-book display controller corresponding to the configured EPD mode among said at least two e-book display screen controllers being turned on, and remaining e-book display screen controllers being turned off;; when configuring the SOC as the single LCD mode, the LCD controller mode being turned on, and said at least two e-book display screen controllers being turned off; when configuring the SOC as the single EPD mode, the e-book display controller corresponding to the configured EPD mode among said at least two e-book display screen controllers being turned on, and remaining e-book display screen controllers being turned off.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating an SOC for supporting multiple display screens, according to an exemplary embodiment of the inventive concept;

FIG. 2 is a block diagram illustrating the SOC of FIG. 1, according to an exemplary embodiment of the inventive concept;

FIG. 3 is a block diagram illustrating the bridge module of FIG. 2, according to an exemplary embodiment of the inventive concept;

FIG. 4 is a flowchart illustrating the procedure for configuring the SOC as different EDP modes according to the type of the e-book display screen, according to an exemplary embodiment of the inventive concept;

FIG. 5 is a diagram of the operation of the SOC of an exemplary embodiment of the inventive concept when an LCD controller module operates; and

FIG. 6 is a flowchart illustrating the procedure for configuring EDP/LCD multi-panel mode.

### DETAILED DESCRIPTION OF EXEMPLARY EMBODIMENTS

Exemplary embodiments of the inventive concept will be described more fully hereinafter with reference to the accompanying drawings. Like reference numerals may refer to like elements throughout the accompanying drawings.

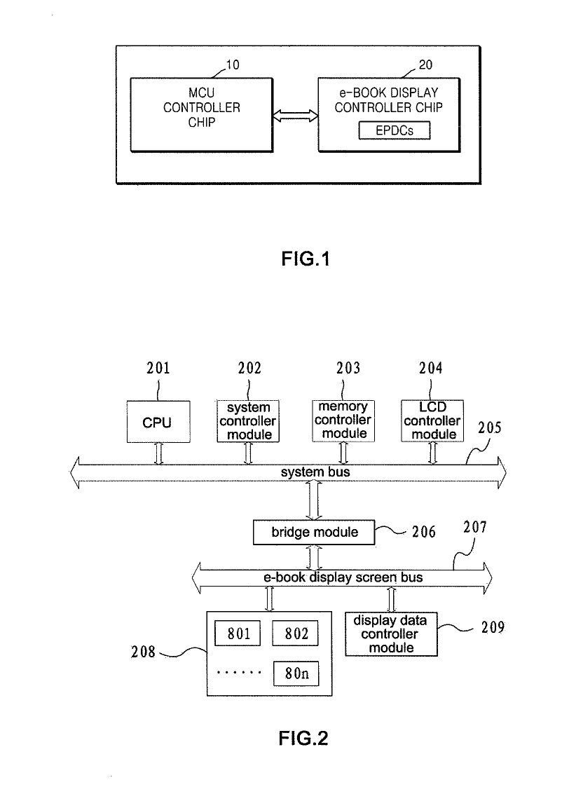

FIG. 1 is a block diagram illustrating an SOC for supporting multiple display screens, according to an exemplary embodiment of the inventive concept.

Referring to FIG. 1, An SOC includes a microprocessor (MCU) controller 10 and an e-book display screen (EPD) controller 20. The e-book display screen controller 20 includes at least two e-book display screen controllers (EPDCs) for controlling the e-book display (EPD) panels in different modes.

FIG. 2 is a block diagram illustrating the SOC of FIG. 1, according to an exemplary embodiment of the inventive concept. Referring to FIGS. 1 and 2, the SOC may include a CPU 201 such as RISC central processor, a system controller module 202a memory controller module 203, a system bus 205, a bridge module 206, an e-book display screen bus 207, an e-book display screen controller module 208 and a display data controller module 209. In addition, the SOC of the e-book reader may further include an LCD controller module 204 for driving LCD panel. The CPU 201, the system controller module 202 and the memory controller module 203 may be included in the microprocessor controller module 10.

The CPU 201, the system controller module 202, the memory controller module 203 and the LCD controller module 204 may be connected to the system bus 205, and communicate with the display data controller module 209 via the system bus 205.

The bridge module 206 may be connected between the system bus 205 and the e-book display screen bus 207.

The e-book display screen controller module 208 and the display data controller module 209 may be connected to the e-book display screen bus 207, and communicate with the CPU 201, the system controller module 202 and the memory controller module 203 through the e-book display screen bus 207 via the bridge module 206 and the system bus 205.

The e-book display screen controller module 208 may include at least two e-book display screen controllers (EPDCs) (such as 801, 802, . . . 80n as shown in FIG. 2, wherein, n is a positive integer greater than or equal to 2) for controlling EPD panels in different modes. Each of e-book display screen controllers may control EPD panel in one mode, thus a plurality of e-book display screen controllers may control EPD panels in various modes.

The plurality of e-book display screen controllers may be integrated together to form the e-book display screen controller module 208, and they may share the display data controller module 209. The display data controller module 209 may generate EPD data according to different EPD modes.

It is possible to reduce the hardware cost while increasing the chip performance, through a manner that the plurality of the EPDCs share one display data controller module 209, according to an exemplary embodiment of the inventive concept.

In addition, the display data controller module 209 and the e-book display screen controller module 208 singly occupy the e-book display screen bus 207, thereby enhancing the bus bandwidth and performance of the e-book display system.

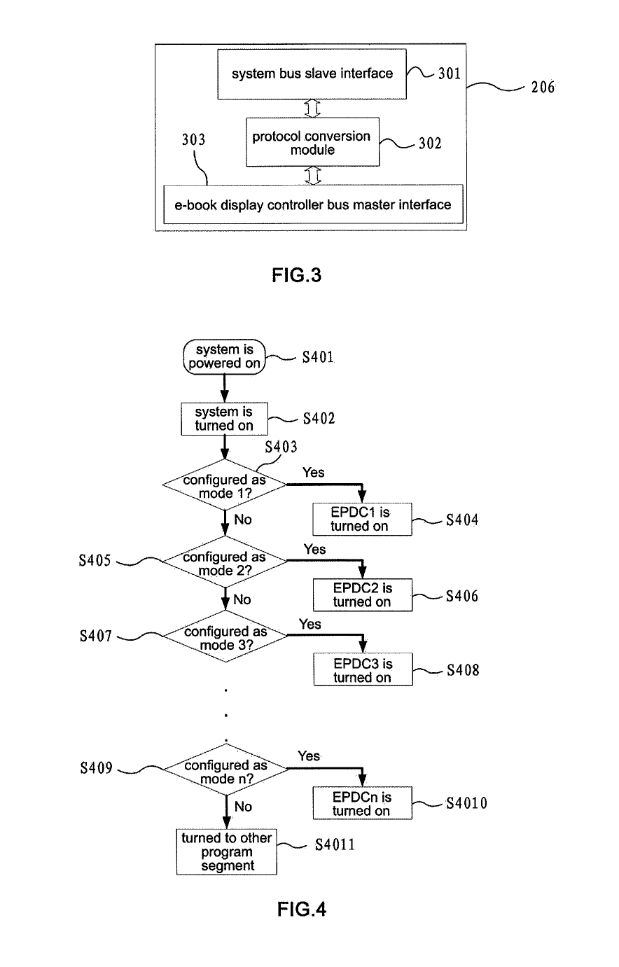

FIG. 3 is a block diagram illustrating the bridge module of FIG. 2, according to an exemplary embodiment of the inventive concept. Referring to FIG. 3, the bridge module 206 may include a system bus slave interface 301, a protocol conversion module 302 and an e-book display controller bus master interface 303. The protocol conversion module 302 may be connected between the system bus slave interface 301 and the e-book display controller bus master interface 303, for achieving the conversion between the system bus protocol and the e-book display screen bus protocol.

FIG. 4 is a flowchart illustrating the procedure for configuring the SOC as different EDP modes according to the type of the e-book display screen, according to an exemplary embodiment of the inventive concept. Referring to FIG. 4, in step 5401, the system of the SOC with multi-mode according to an exemplary embodiment of the inventive concept may be powered on. As shown in FIG. 2, since there are at least two EPDCs, at least two EPD modes can be configured.

In step S402, the system of the SOC may be turned on. The system of the SOC according to an exemplary embodiment of the inventive concept may operate multi-bus and multi-mode.

Subsequently, the CPU of the SOC with multi-bus multi-mode according to an exemplary embodiment of the inventive concept judges and configures EPD mode according to the type of the e-book display screen, so that an EPDC corresponding to the corresponding EPD mode is turned on and other EPDCs are turned off.

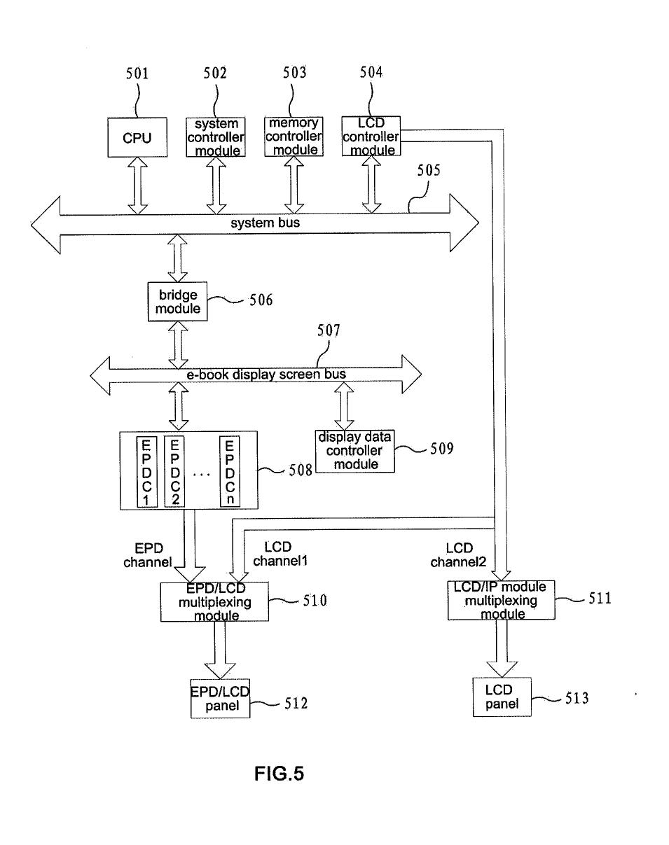

For example, in step S403, the CPU may judge whether to configure the SOC as mode 1. When it is judged to configure the SOC as mode 1, the e-book display screen controller 1 (EPDC1) may be turned on and is in normal operation state, and remaining EPDCs, such as, EPDC2, EPDC3, . . . EPDCn (wherein, n is a positive integer greater than or equal to 2) may be in low-power consumption off state, in step S404. EPDCs, such as EPDC1, EPDC2, . . . EPDCn according to an exemplary embodiment of the inventive concept are illustrated in FIG. 5.

If the CPU judges not to configure the SOC as mode 1 in step S403, the CPU may judge whether to configure the SOC as mode 2 in step S405. When it is judged to configure the SOC as mode 2, the EPDC2 may be turned on and may be in normal operation state, and remaining EPDCs, such as, EPDC1, EPDC3, . . . EPDCn (wherein, n is a positive integer greater than or equal to 2) may be in low-power off state consumption, in step S406.

In the same way, if the CPU judges not to configure the SOC as mode 2 in step S405, CPU may judge whether to configure the SOC as mode 3 in step S407. When it is judged to configure the SOC as mode 3, the EPDC3 may be turned on and may be in normal operation state, and remaining EPDCs, such as, EPDC1, EPDC2, . . . EPDCn (wherein, n is a positive integer greater than or equal to 2) may be in low-power consumption off state, in step S408.

That is, the CPU may judge whether to configure the SOC as mode m (1≦m≦n) in turn. When it is judged to configure the SOC as mode m, the EPDCm may be turned on, and remaining EPDCs may be in low-power consumption off state.

In step S409, the CPU may judge whether to configure the SOC as mode n. When it is judged to configure the SOC as mode n, the EPDCn may be turned on, and remaining EPDCs, such as, EPDC1, EPDC2, . . . EPDCn-1 may be in low-power consumption off state.

When the CPU judges not to configure the SOC as any mode, the CPU may be turned to other program segment to perform corresponding program in step S4011.

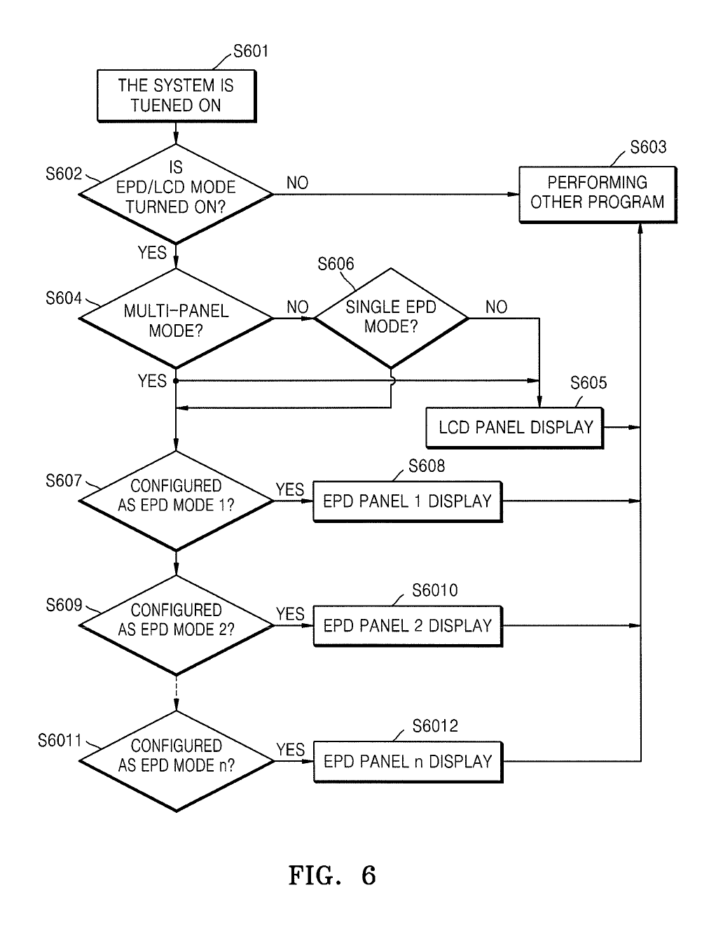

FIG. 5 is a diagram of the operation of the SOC of an exemplary embodiment of the inventive concept when the LCD controller module operates, and FIG. 6 is a flowchart illustrating the procedure for configuring EDP/LCD multi-panel mode.

In FIG. 5, a CPU 501, a system controller module 502, a memory controller module 503, a LCD controller module 504, a system bus 505, a bridge module 506, an e-book display screen bus 507, an e-book display screen controller module 508 and a display data controller module 509 may be the same as the CPU 201, the system controller module 202, the memory controller module 203, the LCD controller module 204, the system bus 205, the bridge module 206, the e-book display screen bus 207, the e-book display screen controller module 208 and the display data controller module 209 in FIG. 2, and the procedure of the operation of the SOC when the LCD controller module 504 operates will be described below in detail.

In the case that the SOC of an exemplary embodiment of the inventive concept may include the LCD controller module 504 and the e-book display screen controller module 508 at the same time, the SOC may support multiple e-book display screens and the LCD screen at the same time.

As shown in FIG. 5, the LCD controller module 504 may have two output paths, i.e. an LCD channel 1 and an LCD channel 2. The LCD channel 1 and an EPD channel may be connected to an EPD/LCD multiplexing module 510, thereby the LCD channel 1 and the EPD channel may be multiplexed, and may be connected to an EPD/LCD panel 512 finally. The LCD channel 2 may be connected to an LCD/IP (Intellectual Property) module multiplexing module 511, thereby the LCD channel 2 and the IP module may be multiplexed, and may be connected to the LCD panel 513 finally. Therefore, different content also can be displayed on the e-book display screen and LCD respectively at the same time through configuring; and different content can be displayed in the e-book display screen and the LCD respectively by configuring to illuminate the e-book display screen and the LCD at different time.

The procedure for configuring an EDP/LCD multi-panel mode will be described below with reference to FIG. 6.

As shown in FIG. 6, in step S601, the system may be turned on. In step S602, the CPU may determine whether the user turns on EPD/LCD mode.

When CPU determines that the EPD/LCD mode is not turned on in step S602, other program may be performed in step S603.

When CPU determines that EPD/LCD mode is turned on in step S602, CPU may performs configuration of a multi-panel mode and a single-panel mode.

For example, in step S604, the CPU may determine whether the user selects the multi-panel mode. When it is determined that the user selects the multi-panel mode, the LCD controller module may be turned on and the LCD controller module drives the LCD panel to display (S605. For example, when the LCD controller module may drive the LCD panel to display, the LCD controller module may open the LCD channel 2.

Also, when it is determined that the user selects the multi-panel mode in step S604, one of at least two of EPDCs may be turned on and the one of EPDCs may drive a corresponding EPD panel to display (S607-S6012). When the CPU determines that the SOC is configured as EPD mode 1 (S607), the EPDC 1 may be turned on, and remaining EPDCs may be turned off, and the EPDC 1 shall occupy the EPDC channel, thereby driving the EPD panel 1 to display (S608); when the CPU determines that the SOC is configured as EPD mode 2 (S609), the EPDC 2 may be turned on, and remaining EPDCs may be turned off, and the EPDC2 shall occupy the EPDC channel, so that the EPDC2 drives EPD panel 2 to display (S6010); as such, when the CPU determines that the SOC is configured as EPD mode m (1≦m≦n), the EPDCm may be turned on, and remaining EPDCs may be turned off, and the EPDCm shall occupy the EPDC channel, so that the EPDCm drives EPD panel m to display; Finally, when the CPU determines that the SOC is configured as EPD mode n (S6011), the EPDCn may be turned on, and remaining EPDCs may be turned off, and the EPDCn shall occupy EPDC channel, so that the EPDCn drives EPD panel n to display (S6012). Through such an operation, one of EPD panels and LCD panel may display at the same time.

For example, if it is determined that the user does not select the multi-panel mode in step S604, it may be determined that the user selects single-panel display. For example, in step S606, it may be determined whether the user selects a single EPD mode. When it is determined that the user selects the single EPD mode, steps S607-S6012 may be performed (the detail description is omitted because it is described in detail before).

If it is determined that the user does not select the multi-panel mode in step S604 and the single EPD mode in step S606, it may be determined that the user selects an LCD mode. Thus, the LCD controller mode may be turned on, the LCD controller module may drive the LCD panel to display (S605), and all the EPDCs may be turned off at this time. The LCD controller module may open the LCD channel 1 or the LCD channel 2. Thus, in the case of selecting a single panel mode, switching display between the LCD panel and the EPD panel can be realized when switching the LCD mode and the EPD mode.

According to the SOC of the e-book reader and the configuration method thereof according to exemplary embodiments of the inventive concept, the SOC adopts multi-bus structure and integrates internally a LCD display controller and at least two e-book display controllers (EPDCs); the configuration method may configure the SOC as different display modes, and the SOC may support display of LCD and EPD simultaneously and individually, and may support various e-book display screens when EPD display is performed, thus possesses compatibility, thereby significantly reducing the system cost of the e-book reader.

Although the inventive concepts have been shown and described with reference to the embodiments thereof, it would be appreciated by those skilled in the art that changes may be made in form and details without departing from the principles and spirit of the following claims.

What is claimed is:

1. A system on a chip (SOC) for supporting multiple display screens, comprising:
a microprocessor controller module and an e-book display screen controller module,
wherein, the e-book display screen controller module includes at least two e-book display screen controllers for controlling e-book display screen (EPD) panels in different modes.

2. The SOC of claim 1, wherein, the SOC further comprises: a system bus, a bridge module, an e-book display screen bus and a display data controller module,
wherein, the microprocessor controller module is connected to the system bus, the bridge module is connected between the system bus and the e-book display screen bus, the e-book display screen controller module and the display data controller module are connected to the e-book display screen bus, and communicate with the microprocessor controller module through the e-book display screen bus via the bridge module and the system bus.

3. The SOC of claim 2, wherein, the SOC further comprises: a LCD controller module for controlling an LCD and connected to the system bus,
wherein, the LCD controller module has a first LCD channel and a second LCD channel, the first LCD channel and an EPD channel of the e-book display screen controller module are multiplexed to be connected with an EPD panel or LCD panel, and the second LCD channel and a IP module are multiplexed be to connected with the LCD panel.

4. The SOC of claim 2, wherein, the bridge module comprises a system bus slave interface, a protocol conversion module and an e-book display controller bus master interface, wherein, the protocol conversion module is connected between the system bus slave interface and the e-book display controller bus master interface.

5. The SOC of claim 2, wherein, the microprocessor controller module comprises a CPU, a system controller module and a memory controller module connected with the system bus, respectively.

6. The SOC of claim 2, wherein, said at least two e-book display screen controllers are integrated together to form the e-book display screen controller module and share one display data controller module, and the display data controller module generates corresponding EPD data according to different EPD modes.

7. The SOC of claim 2, wherein, the display data controller module and the e-book display screen controller module singly occupy the e-book display screen bus.

8. A configuration method of a system on a chip (SOC) for supporting multiple display screens, the SOC comprising a microprocessor controller module and an e-book display screen controller module, wherein, the e-book display screen controller module includes at least two e-book display screen controllers for controlling the e-book display screen (EPD) panels in different modes, wherein, the configuration method comprising:
judging an EPD mode according to the type of the e-book display screen by the microprocessor controller module;
configuring an EPD mode of the SOC according to the judged EPD mode by the microprocessor controller module; and
turning on an e-book display screen controller corresponding to the configured EPD mode among said at least two e-book display screen controllers, and remaining e-book display screen controllers being in off state.

9. The configuration method of claim 8, wherein, further comprises:
configuring the SOC as one of a multi-panel mode and a single-panel mode, wherein the SOC further comprises a LCD controller module, and the single-panel mode includes a single LCD mode and a single EPD mode.

10. The configuration method of claim 9, further comprising:
when configuring the SOC as the multi-panel mode, LCD controller mode being turned on, the e-book display controller corresponding to the configured EPD mode among said at least two e-book display screen controllers being turned on, and remaining e-book display screen controllers being turned off;
when configuring the SOC as the single LCD mode, the LCD controller mode being turned on, and said at least two e-book display screen controllers being turned off;
when configuring the SOC as the single EPD mode, the e-book display controller corresponding to the configured EPD mode among said at least two e-book display screen controllers being turned on, and remaining e-book display screen controllers being turned off.
